(19) United States
(12) Patent Application Publication
(10) Pub. No.: US 2025/0229254 A1
(43) Pub. Date: Jul. 17, 2025

(54) DESORPTION SYSTEM

(71) Applicant: Mosaic Materials, Inc., Alameda, CA (US)

(72) Inventors: Steven Russell, The Woodlands, TX (US); Dustin Kraft, Houston, TX (US); Samuel Cheng, Katy, TX (US); John Battaglioli, Ballston Lake, NY (US)

(21) Appl. No.: 18/414,755

(22) Filed: Jan. 17, 2024

(51) Int. Cl. B01J 20/34

(52) U.S. Cl. CPC B01J 20/3441

(57) ABSTRACT

A system includes a chamber having a sorbent therein and forming a part of a flow loop, a gas inlet line configured to flow a fluid including gas(es), vapor(s), or a mixture thereof into the chamber such that the gas(es), vapor(s), or the mixture thereof is adsorbed by the sorbent, a gas outlet line configured to receive, from the chamber, the fluid with at least some of the gas(es), vapor(s), or the mixture thereof removed therefrom, a radio frequency (RF) system configured to provide electromagnetic energy to the sorbent within the chamber to heat the sorbent and release the gas(es), vapor(s), or the mixture thereof from the sorbent. The system is configured to induce a flow of the gas(es), vapor(s), or the mixture thereof released from the sorbent through the flow loop.

### BACKGROUND

Various manufacturing and chemical systems include the use of sorbents to remove gas(es), vapor(s), or a mixture thereof from a fluid via adsorption. For example, carbon capture systems may capture carbon dioxide via adsorption with sorbent(s). The sorbents may then be fed to a desorption system to remove the gas(es), vapor(s), or the mixture thereof from the sorbent. Improvement in the desorption system may be desirable.

### SUMMARY

An embodiment of a desorption system, including a chamber configured to hold sorbent therein and forming part of a flow loop, and a radio frequency (RF) system configured to provide electromagnetic energy to the sorbent within the chamber, wherein the desorption system is configured to induce flow through the flow loop.

An embodiment of a system, including a chamber comprising a sorbent therein and forming a part of a flow loop, a gas inlet line configured to flow a fluid including gas(es), vapor(s), or a mixture thereof into the chamber such that the gas(es), vapor(s), or the mixture thereof is adsorbed by the sorbent, a gas outlet line configured to receive, from the chamber, the fluid with at least some of the gas(es), vapor(s), or the mixture thereof removed therefrom, a radio frequency (RF) system configured to provide electromagnetic energy to the sorbent within the chamber to heat the sorbent and release the gas(es), vapor(s), or the mixture thereof from the sorbent, wherein the system is configured to induce a flow of the gas(es), vapor(s), or the mixture thereof released from the sorbent through the flow loop.

An embodiment of a method for operating a desorption system, including heating a sorbent in a chamber of the desorption system via electromagnetic energy to release gas(es), vapor(s), or a mixture thereof from the sorbent, and inducing flow of the gas(es), vapor(s), or the mixture thereof released from the sorbent through a flow loop that includes the chamber to heat at least a portion of the sorbent to release more of the gas(es), vapor(s), or the mixture thereof from the sorbent.

### BRIEF DESCRIPTION OF THE DRAWINGS

The following descriptions should not be considered limiting in any way. With reference to the accompanying drawings, like elements are numbered alike:

FIG. 1 is a perspective view of a system including a desorption system according to one or more embodiments;

FIG. 2 is a bottom view of the system of FIG. 1.

FIG. 3 shows a schematic block diagram of a system including a desorption system according to one or more embodiments;

FIG. 4 shows a schematic block diagram of a desorption system according to one or more embodiments;

FIG. 5 shows a flow diagram of an adsorption process according to one or more embodiments; and

FIG. 6 shows a flow diagram of a desorption process according to one or more embodiments.

### DETAILED DESCRIPTION

A detailed description of one or more embodiments of the disclosed apparatus and method are presented herein by way of exemplification and not limitation with reference to the Figures.

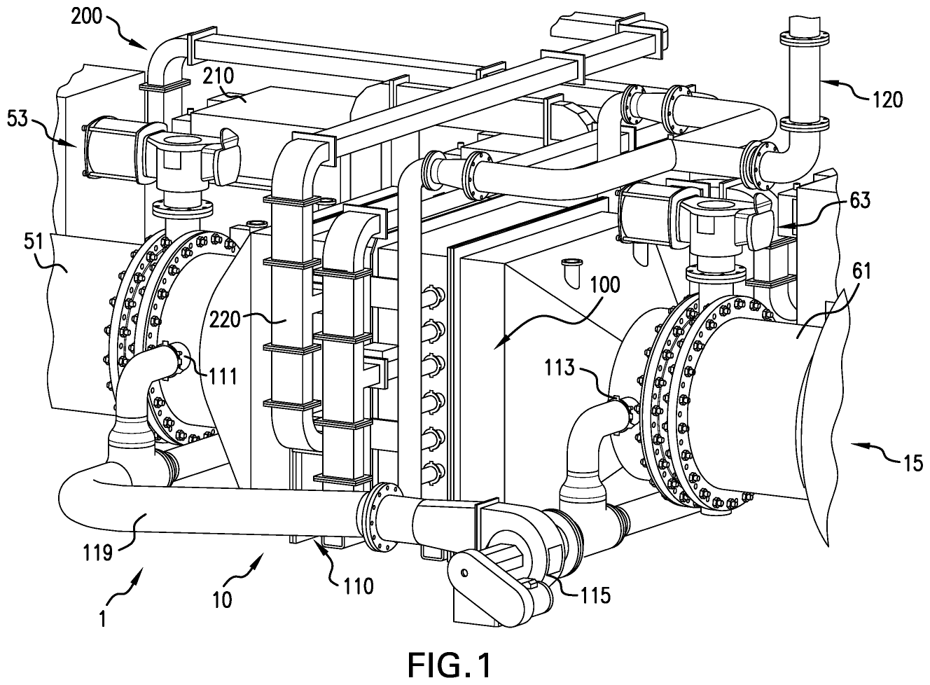

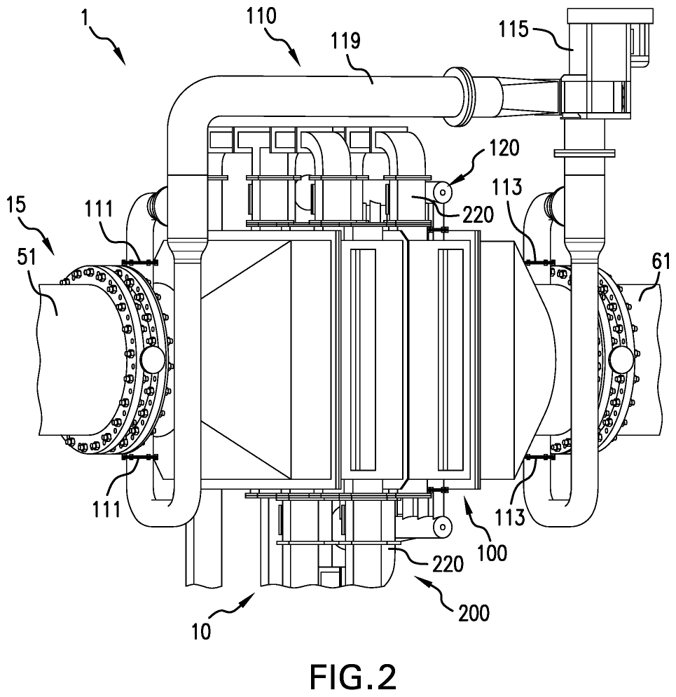

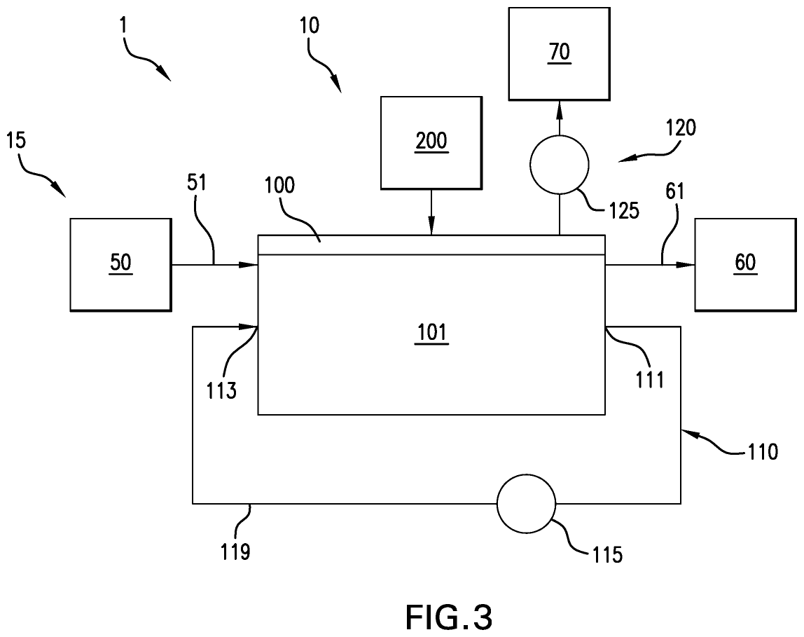

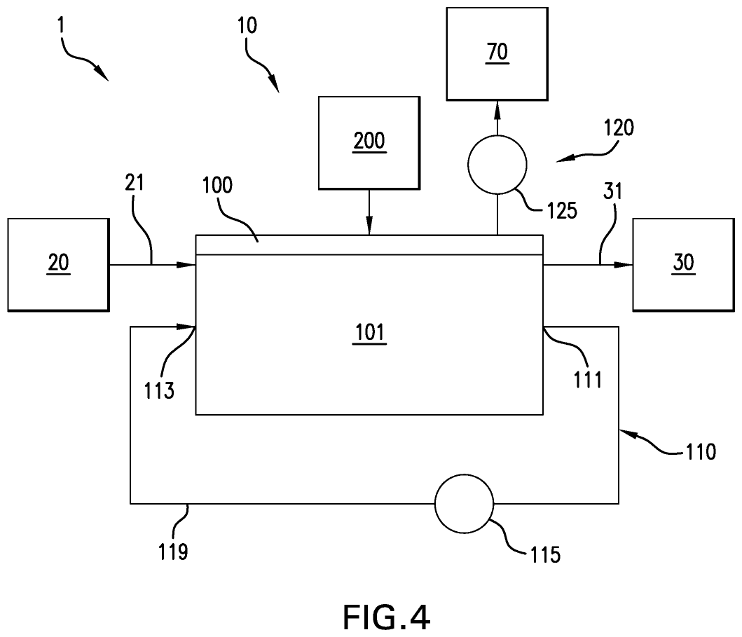

A system 1 according to one or more embodiments is shown in FIGS. 1 and 2, and a schematic block diagram of a system 1 according to one or more embodiments is shown in FIG. 3. The system 1 may include both an adsorption system 15 and a desorption system 10. The system 1 may include only a desorption system 10 without an adsorption system 15 (see FIG. 4).

In one or more embodiments in which the system 1 includes both an adsorption system 15 and a desorption system 10, the adsorption system 15 and the desorption system 10 may both include a chamber 100, with the chamber 100 functioning as an adsorption chamber or contactor within the adsorption system 15 and functioning as a desorption chamber within the desorption system 10. The chamber 100 may be an example of an adsorption chamber or a contactor. The chamber 100 may be an example of a desorption chamber.

The chamber 100 may include sorbent 101 therein. The sorbent 101, may be, for example, metal-organic frameworks, Zeolites, amine-impregnated porous materials, amine-functionalized porous materials, or a combination of one or more of the above. The sorbent 101 may be another sorbent known in the art or a combination of sorbents including those known in the art. The chamber 100 may be disposed downstream of a gas source 50 and may receive a gas from the gas source 50 through a gas inlet line 51. The gas source 50 may be, for example, atmospheric such that the chamber 100 may be part of a direct air capture system that receives atmospheric gas. The gas source 50 may be, for example, a manufacturing system, a chemical system, or a refinery system, and chamber 100 may receive flue gas or other types of gas produced in the manufacturing system, the chemical system, or the refinery system. The gas from the gas source 50 may pass through the chamber 100 and the sorbent 101 therein such that gas(es), vapor(s), or a mixture thereof may be adsorbed by the sorbent 101 in the chamber 100. The chamber 100 may be disposed upstream of a gas destination 60 such that the gas from the gas source 50, after having the gas(es), vapor(s), or the mixture thereof adsorbed therefrom by the sorbent 101 in the chamber 100, is fed to the gas destination 60 through a gas outlet line 61. The gas destination 60 may be, for example, a tank or the atmosphere.

As shown in FIG. 1, an inlet valve 53 may be disposed on the gas inlet line 51 and an outlet valve 63 may be disposed on the gas outlet line 61. The inlet valve 53 and the outlet valve 63 may open to allow gas from the gas source 50 to pass through the chamber 100 to the gas destination 60 for an adsorption process, or may close to isolate the chamber 100 from the gas source 50 and the gas destination 60 for a desorption process. The adsorption system 15 may include the gas inlet line 51, the inlet valve 53, the chamber 100, and the gas outlet line 61, and the outlet valve 63.

As the gas from the gas source 50 is passed through the chamber 100 to the gas destination 60, the sorbent 101 in the chamber 100 may adsorb gas(es), vapor(s), or mixture thereof. After a period of adsorption, the sorbent 101, which starts as lean sorbent, may become rich sorbent.

As used herein, the term rich sorbent denotes a sorbent 101 that has adsorbed gas(es), vapor(s), or a mixture thereof, and the term lean sorbent denotes that the sorbent 101 has not yet adsorbed the gas(es), vapor(s), or the mixture thereof, or the gas(es), vapor(s), or the mixture thereof has been removed, partially or entirely, from the sorbent 101 via the desorption system 10. Examples of the sorbent 101 may include, but are not limited to, [insert list here]. Examples of gas(es), vapor(s), or a mixture thereof adsorbed by the sorbent and 101 removed by the desorption system 10 may include, but are not limited to, CO₂, H₂O, H₂, O₂, N₂, CO, NH₃, C₂H₄, C₂H₆, C₃H₆, C₃H, H₂S, SO₂, and NO₂.

The desorption system 10 may include the chamber 100. Within the desorption system 10, the chamber 100 may be a desorption chamber. The desorption system 10 may further include a radio frequency (RF) system 200 configured to emit electromagnetic energy. The RF system 200 includes an RF generator 210 and an RF waveguide 220 extending from the RF generator 210 to the chamber 100. The RF generator 210 may be configured to generate electromagnetic energy, and the RF waveguide 220 may be configured to propagate the electromagnetic energy by the RF generator 210 to the chamber 100. The RF system 200 may heat the sorbent 101 within the chamber 100 which may release gas(es), vapor(s), or a mixture thereof from the sorbent 101 that previously adsorbed the gas(es), vapor(s), or the mixture thereof. As shown in FIG. 1, the desorption system 10 may include a plurality of RF waveguides 220, and each of the RF waveguides 220 may be coupled to the chamber 100 at multiple locations. Examples of the electromagnetic energy emitted by the RF system 200 includes but are not limited to microwave energy, which may be in a range of 300 MHz to 5 GHz, and induction heating, which may be in a range of 100 kHz to 200 kHz.

An RF system 200 providing electromagnetic energy to the chamber 100 may heat the sorbent 101 within the chamber 100 in a relatively short period to quickly release gas(es), vapor(s), or a mixture thereof from the sorbent 101. However, through extensive testing and analysis, the inventors unexpectedly discovered that the sorbent 101 may not be uniformly heated by the electromagnetic energy from the RF system 200. That is, the inventors made an unexpected discovery of cold spots in the sorbent 101 within the chamber 100. Having made this unexpected discovery, the inventors recognized that the efficiency of the desorption system 10 that uses the RF system 200 to heat the sorbent 101 via electromagnetic energy could be improved by manipulating a temperature profile of the sorbent 101 within the chamber 100 to create greater uniformity as more of the gas(es), vapor(s), or the mixture thereof may be released from the previously cold spots.

The desorption system 10 may further include a flow loop 110 formed by external piping 119 and the chamber 100. The external piping 119 may extend between a desorption chamber inlet 111 and a desorption chamber outlet 113.

A blower 115 may be disposed in the flow loop 110. The blower 115, when powered, may draw gas(es), vapor(s), or a mixture thereof released from the sorbent within the chamber 100 through the flow loop 110. That is, the blower 115 may induce flow through the flow loop 110. For example, the blower 115 may draw the gas(es), vapor(s), or the mixture thereof via the desorption chamber outlet 113, through the external piping 119 to the desorption chamber inlet 111, then through the chamber 100 back to the desorption chamber outlet 113. The gas(es), vapor(s), or the mixture thereof may be forced through the sorbent 101 within the chamber 100. The blower 115 may be disposed on the external piping 119 between the desorption chamber inlet 111 and the desorption chamber outlet 113. The blower 115 may be an example of a first blower. The desorption system 10 may not include a heater other than the RF system 200. The flow loop 110 outside of the chamber 100 may not include a heater.

As the RF system 200 heats the sorbent 101 to release the gas(es), vapor(s), or the mixture thereof, the gas(es), vapor(s), or the mixture thereof are released at elevated temperatures. As the gas(es), vapor(s), or the mixture thereof are fed back into the chamber 100 and forced through the sorbent 101, the gas(es), vapor(s), or the mixture thereof may heat the cold spots within the sorbent 101, improving uniformity of the temperature profile of the sorbent 101 within the chamber 100. Therefore, the flow loop 110 may improve efficiency of the desorption system 10.

The desorption system 10 further includes a vacuum line 120. A blower 125 may be disposed in the vacuum line 120. The blower 125, when powered, may draw gas(es), vapor(s), or a mixture thereof released from the sorbent 101 within the chamber 100 from the chamber 100 through the vacuum line 120. The blower 125 may be an example of a second blower. The vacuum line 120 may be fluidly connected to a tank 70 to hold the gas(es), vapor(s), or the mixture thereof drawn from the chamber 100.

The blower 125 may also be employed to draw gas from the desorption chamber prior to the RF system 200 providing electromagnetic energy to the chamber 100. That is, gas(es) within the chamber 100 prior to release of the gas(es), vapor(s), or the mixture thereof from the sorbent 101 may be drawn out of the desorption chamber by the blower 125 via the vacuum line 120 to reduce pressure within the desorption chamber and/or create a vacuum within the chamber 100.

FIG. 4 shows a system 1 according to one or more embodiments. While FIGS. 1-3 show a system 1 that may include both an adsorption system 15 and a desorption system 10, the system 1 in FIG. 4 includes only a desorption system 10. The desorption system 10 itself is similar to that shown in FIGS. 1-3. However, instead of a gas source 50 and a gas destination 60, the chamber 100 is disposed downstream of a sorbent source 20 and upstream of a sorbent destination 30. The chamber 100 is configured to receive rich sorbent from the sorbent source 20 via a sorbent inlet line 21, and the desorption system 10 removes the gas(es), vapor(s), or the mixture thereof from the rich sorbent to form lean sorbent. The lean sorbent is then fed from the chamber 100 to the sorbent destination via a sorbent outlet line 31. According to one or more embodiments, instead of employing a sorbent inlet line 21 and a sorbent outlet line 31, the chamber 100 may have one or more openings such as a door(s) to feed the rich sorbent transported from the sorbent source 20 into the chamber 100 and to remove the lean sorbent from the chamber 100 to transport to the sorbent destination 30 in bulk form. The sorbent source 20 and the sorbent destination 30 may be different locations or the same location. The sorbent source 20 and/or the sorbent destination may be an adsorption system(s).

While FIGS. 1-4 show a blower 125 for vacuuming the gas(es), vapor(s), or the mixture thereof released from the sorbent 101, a vacuum pump may be employed instead of the blower 125 or in addition thereto.

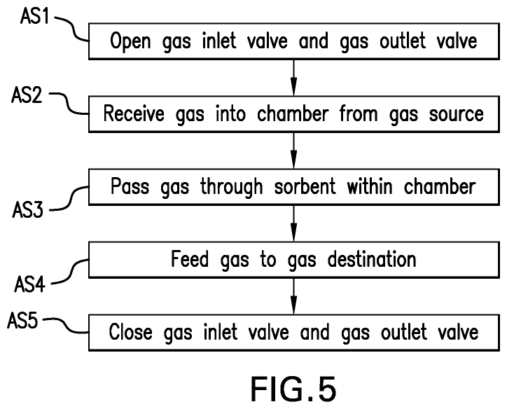

An adsorption process according to one or more embodiments is shown in FIG. 5. In step AS1, a gas inlet valve 53 and a gas outlet valve 63 may be opened. If the gas inlet valve 53 and/or the gas outlet valve 63 are already open prior to the adsorption process, opening the gas inlet valve 53 and/or the gas outlet valve 63 may be skipped. In step AS2, gas from a gas source 50 is received into a chamber 100 having sorbent 101 therein via a gas inlet line 51. In step AS3, the gas is passed through the sorbent 101 within the chamber 100 such that gas(es), vapor(s), or a mixture thereof may be adsorbed into the sorbent 101 from the gas. In step AS4, the gas with the gas(es), vapor(s), or the mixture thereof removed by the sorbent 101 may be fed to the gas destination 60 via a gas outlet line 61. In step AS5, the gas inlet valve 53 and the gas outlet valve 63 may be closed.

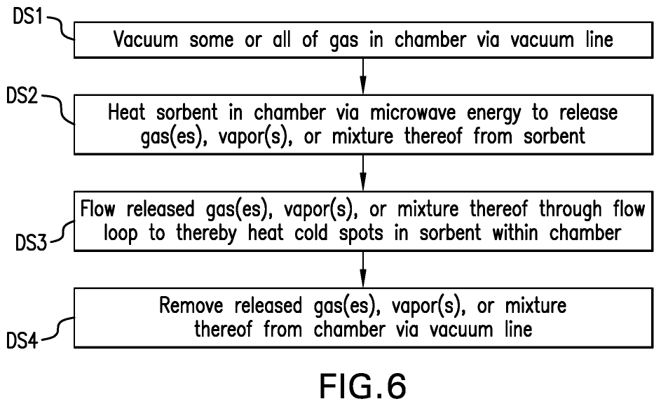

A desorption process according to one or more embodiments is shown in FIG. 6. In step DS1, some or all of gas in a chamber 100 may be vacuumed via a vacuum line 120. Depending on application, the desorption process may skip step DS1. In step DS2, sorbent 101 in the chamber 100 may be heated via electromagnetic energy from an RF system 200 to release gas(es), vapor(s), or a mixture thereof from the sorbent 101. The electromagnetic energy may be generated by an RF generator 210 of the RF system 200 and propagated by RF waveguides 220 of the RF system 200. The heating in step DS2 may occur until a predetermined pressure level is reached. In step DS3, the gas(es), vapor(s), or the mixture thereof released from the sorbent 101 is flowed through a flow loop 110 to heat cold spots in the sorbent 101 within the chamber 100 to release further gas(es), vapor(s), or a mixture thereof from the cold spots of the sorbent. The flow loop 110 may include the chamber 100 and external piping 119. A blower 115 may be disposed on the external piping 119 to induce flow through the flow loop 110. As the gas(es), vapor(s), or the mixture thereof is released from the sorbent 101 in steps DS2 and DS3, some of the gas(es), vapor(s), or the mixture released from the sorbent 101 may be evacuated form the chamber 100 to avoid pressure buildup above the predetermined pressure level. In step DS4, the gas(es), vapor(s), or the mixture thereof released from the sorbent 101 remaining in the chamber 100 is removed from the chamber 100 via a vacuum line 120. A blower 125 or a vacuum pump may be disposed on the vacuum line 120 to generate a vacuum flow from the chamber 100.

According to one or more embodiments, the desorption process shown in FIG. 6 may follow the adsorption process shown in FIG. 5.

According to one or more embodiments, prior to step DS2, the chamber 100 may be fluidly isolated from the vacuum line 120. The isolating may be accomplished, for example, by shutting a valve. As the sorbent 101 is heated in step DS2, a pressure within the chamber 100 may rise as the gas(es), vapor(s), or the mixture thereof released from the sorbent 101. When the pressure within the chamber 100 reaches a predetermined threshold, the blower 115 may be activated to generate flow of the heated gas(es), vapor(s), or the mixture thereof released from the sorbent 101.

As the gas(es), vapor(s), or the mixture thereof are released from the sorbent 101 vacuum line 120 in step DS2 and/or step DS3, some of the gas(es), vapor(s), or the mixture within the chamber 100 may be removed from the chamber 100 via the vacuum line 120 to keep the pressure within the chamber 100 within a predetermined range.

While steps DS2 and DS3 are shown as separate steps, the heating of the sorbent 101 in the chamber 100 via electromagnetic energy from the RF system 200 in step DS2 may continue through step DS3. That is, the RF system 200 may continue to heat the sorbent 101 as the flow is induced through the flow loop 110.

According to one or more embodiments, the desorption process of FIG. 6 may be a continuous process. For example, the RF system 200 may continue to heat the sorbent 101 as the flow is induced through the flow loop 110 to make the temperature profile of the sorbent 101 more uniform in step DS3, and some of the gas(es), vapor(s), or the mixture thereof within the chamber 100 may be removed from the chamber 100 via the vacuum line 120 to keep the pressure within the chamber 100 within a predetermined range. The heating of the sorbent 101 in the chamber 100 via the electromagnetic energy, the inducing of the flow through the flow loop 110, and the removing of the some of the gas(es), vapor(s), or the mixture thereof from the chamber 100 to maintain pressure may occur continuously until the sorbent 101 has undergone satisfactory desorption.

According to one or more embodiments, in addition to flowing the gas(es), vapor(s), or the mixture thereof released from the sorbent 101 through the flow loop 110, an additional gas stream may be injected into the flow loop 110.

According to one or more embodiments, the desorption process in FIG. 6 may be a repetition of a discrete process. For example, after the RF system 200 heats the sorbent 101 via electromagnetic energy for a period in step DS2 and the gas(es), vapor(s), or the mixture thereof released from the sorbent 101 increases the pressure within the chamber 100 to a threshold pressure, the RF system 200 may be shut off. Flow is then induced through the flow loop 110 so that the gas(es), vapor(s), or the mixture thereof released from the sorbent 101 heats cold spots within the sorbent 101 to make a temperature profile of the sorbent 101 more uniform in step DS3, which releases additional gas(es), vapor(s), or a mixture thereof. The gas(es), vapor(s), or the mixture thereof is then removed from the chamber 100. This process may be repeated until the sorbent 101 has undergone satisfactory desorption.

Set forth below are some aspects of the foregoing disclosure:

### Embodiment 1

A desorption system, including a chamber configured to hold sorbent therein and forming part of a flow loop, and a radio frequency (RF) system configured to provide electromagnetic energy to the sorbent within the chamber, wherein the desorption system is configured to induce flow through the flow loop.

### Embodiment 2

The desorption system as in any prior embodiment, wherein a first blower is disposed on the flow loop to induce flow therethrough.

### Embodiment 3

The desorption system as in any prior embodiment, wherein no heater is disposed on any portion of the flow loop outside of the chamber.

### Embodiment 4

The desorption system as in any prior embodiment, further comprising a vacuum line fluidly connected to the chamber.

### Embodiment 5

The desorption system as in any prior embodiment, wherein the RF system is configured to provide the electromagnetic energy to the sorbent within the chamber to heat the sorbent to release gas(es), vapor(s), or a mixture thereof from the sorbent, and wherein the desorption system is configured to induce the gas(es), vapor(s), or the mixture thereof through the sorbent to heat at least a portion of the sorbent.

### Embodiment 6

The desorption system as in any prior embodiment, further comprising a vacuum line fluidly connected to the chamber configured to remove the gas(es), the vapor(s), or the mixture thereof in the chamber released from the sorbent.

### Embodiment 7

The desorption system as in any prior embodiment, further comprising a second blower or a vacuum pump disposed on the vacuum line for removing the gas(es), the vapor(s), or the mixture thereof in the chamber released from the sorbent.

### Embodiment 8

The desorption system as in any prior embodiment, wherein the flow loop comprises an external piping coupled to a desorption chamber inlet of the chamber and a desorption chamber outlet of the chamber, and wherein the flow enters the chamber from the external piping via the desorption chamber inlet and exits the chamber to the external piping via the desorption chamber outlet.

### Embodiment 9

The desorption system as in any prior embodiment, wherein a first blower is disposed on the external piping to induce flow through the flow loop.

### Embodiment 10

The desorption system as in any prior embodiment, wherein the RF system comprises an RF generator that generates the electromagnetic energy and at least one RF waveguide that propagates the electromagnetic energy from the RF generator to the chamber.

### Embodiment 11

The desorption system as in any prior embodiment, wherein the at least one RF waveguide is coupled to the chamber at a plurality of locations.

### Embodiment 12

The desorption system as in any prior embodiment, wherein the chamber is coupled to a sorbent inlet line configured to feed the sorbent to the chamber and a sorbent outlet line configured to remove the sorbent from the chamber after the sorbent has undergone a desorption process.

### Embodiment 13

A system, including a chamber comprising a sorbent therein and forming a part of a flow loop, a gas inlet line configured to flow a fluid including gas(es), vapor(s), or a mixture thereof into the chamber such that the gas(es), vapor(s), or the mixture thereof is adsorbed by the sorbent, a gas outlet line configured to receive, from the chamber, the fluid with at least some of the gas(es), vapor(s), or the mixture thereof removed therefrom, a radio frequency (RF) system configured to provide electromagnetic energy to the sorbent within the chamber to heat the sorbent and release the gas(es), vapor(s), or the mixture thereof from the sorbent, wherein the system is configured to induce a flow of the gas(es), vapor(s), or the mixture thereof released from the sorbent through the flow loop.

### Embodiment 14

The system as in any prior embodiment, wherein an inlet valve is disposed on the gas inlet and an outlet valve is disposed on the gas outlet line, and wherein the inlet valve and the outlet valve are configured to close to shut off flow through the gas inlet and the gas outlet line prior to the RF system providing electromagnetic energy to the sorbent within the chamber.

### Embodiment 15

The system as in any prior embodiment, wherein a first blower is disposed on the flow loop to induce the flow of the gas(es), vapor(s), or the mixture thereof therethrough.

### Embodiment 16

The system as in any prior embodiment, wherein no heater is disposed on any portion of the flow loop outside of the chamber.

### Embodiment 17

A method for operating a desorption system, including heating a sorbent in a chamber of the desorption system via electromagnetic energy to release gas(es), vapor(s), or a mixture thereof from the sorbent, and inducing flow of the gas(es), vapor(s), or the mixture thereof released from the sorbent through a flow loop that includes the chamber to heat at least a portion of the sorbent to release more of the gas(es), vapor(s), or the mixture thereof from the sorbent.

### Embodiment 18

The method as in any prior embodiment, wherein the heating the sorbent via the electromagnetic energy and the inducing flow of the gas(es), vapor(s), or the mixture thereof released from the sorbent through the flow loop are performed concurrently.

### Embodiment 19

The method as in any prior embodiment, wherein the heating the sorbent via the electromagnetic energy is performed for a period then stopped, and the inducing flow of the gas(es), vapor(s), or the mixture thereof released from the sorbent through the flow loop is performed after the heating of the sorbent via the electromagnetic energy is stopped.

### Embodiment 20

The method as in any prior embodiment, further comprising removing the gas(es), vapor(s), or the mixture thereof released from the sorbent from the chamber via a vacuum line.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A desorption system, comprising:
a chamber configured to hold sorbent therein and forming part of a flow loop; and a radio frequency (RF) system configured to provide electromagnetic energy to the
sorbent within the chamber,
wherein the desorption system is configured to induce flow through the flow loop.

2. The desorption system of claim 1, wherein a first blower is disposed on the flow loop to induce flow therethrough.

3. The desorption system of claim 1, wherein no heater is disposed on any portion of the flow loop outside of the chamber.

4. The desorption system of claim 1, further comprising a vacuum line fluidly connected to the chamber.

5. The desorption system of claim 1, wherein the RF system is configured to provide the electromagnetic energy to the sorbent within the chamber to heat the sorbent to release gas(es), vapor(s), or a mixture thereof from the sorbent, and wherein the desorption system is configured to induce the gas(es), vapor(s), or the mixture thereof through the sorbent to heat at least a portion of the sorbent.

6. The desorption system of claim 5, further comprising a vacuum line fluidly connected to the chamber configured to remove the gas(es), the vapor(s), or the mixture thereof in the chamber released from the sorbent.

7. The desorption system of claim 6, further comprising a second blower or a vacuum pump disposed on the vacuum line for removing the gas(es), the vapor(s), or the mixture thereof in the chamber released from the sorbent.

8. The desorption system of claim 1, wherein the flow loop comprises an external piping coupled to a desorption chamber inlet of the chamber and a desorption chamber outlet of the chamber, and wherein the flow enters the chamber from the external piping via the desorption chamber inlet and exits the chamber to the external piping via the desorption chamber outlet.

9. The desorption system of claim 8, wherein a first blower is disposed on the external piping to induce flow through the flow loop.

10. The desorption system of claim 1, wherein the RF system comprises an RF generator that generates the electromagnetic energy and at least one RF waveguide that propagates the electromagnetic energy from the RF generator to the chamber.

11. The desorption system of claim 1, wherein the at least one RF waveguide is coupled to the chamber at a plurality of locations.

12. The desorption system of claim 1, wherein the chamber is coupled to a sorbent inlet line configured to feed the sorbent to the chamber and a sorbent outlet line configured to remove the sorbent from the chamber after the sorbent has undergone a desorption process.

13. A system, comprising:
a chamber comprising a sorbent therein and forming a part of a flow loop;
a gas inlet line configured to flow a fluid including gas(es), vapor(s), or a mixture thereof into the chamber such that the gas(es), vapor(s), or the mixture thereof is adsorbed by the sorbent;
a gas outlet line configured to receive, from the chamber, the fluid with at least some of the gas(es), vapor(s), or the mixture thereof removed therefrom;
a radio frequency (RF) system configured to provide electromagnetic energy to the sorbent within the chamber to heat the sorbent and release the gas(es), vapor(s), or the mixture thereof from the sorbent,
wherein the system is configured to induce a flow of the gas(es), vapor(s), or the mixture thereof released from the sorbent through the flow loop.

14. The system of claim 13, wherein an inlet valve is disposed on the gas inlet and an outlet valve is disposed on the gas outlet line, and wherein the inlet valve and the outlet valve are configured to close to shut off flow through the gas inlet and the gas outlet line prior to the RF system providing electromagnetic energy to the sorbent within the chamber.

15. The system of claim 13, wherein a first blower is disposed on the flow loop to induce the flow of the gas(es), vapor(s), or the mixture thereof therethrough.

16. The system of claim 13, wherein no heater is disposed on any portion of the flow loop outside of the chamber.

17. A method for operating a desorption system, comprising: heating a sorbent in a chamber of the desorption system via electromagnetic energy to
release gas(es), vapor(s), or a mixture thereof from the sorbent; and
inducing flow of the gas(es), vapor(s), or the mixture thereof released from the sorbent through a flow loop that includes the chamber to heat at least a portion of the sorbent to release more of the gas(es), vapor(s), or the mixture thereof from the sorbent.

18. The method of claim 17, wherein the heating the sorbent via the electromagnetic energy and the inducing flow of the gas(es), vapor(s), or the mixture thereof released from the sorbent through the flow loop are performed concurrently.

19. The method of claim 17, wherein the heating the sorbent via the electromagnetic energy is performed for a period then stopped, and the inducing flow of the gas(es), vapor(s), or the mixture thereof released from the sorbent through the flow loop is performed after the heating of the sorbent via the electromagnetic energy is stopped.

20. The method of claim 17, further comprising removing the gas(es), vapor(s), or the mixture thereof released from the sorbent from the chamber via a vacuum line.
